(19) United States
(12) Patent Application Publication
(10) Pub. No.: US 2011/0083529 A1
(43) Pub. Date: Apr. 14, 2011

(54) Ratchet mechanism

(76) Inventor: Bu Qin Ruan, Yuhuan Zhejiang (CN)

(21) Appl. No.: 12/806,911

(22) Filed: Aug. 23, 2010

Related U.S. Application Data
(63) Continuation of application No. 10/906,663, filed on Mar. 1, 2005, now abandoned.

(30) Foreign Application Priority Data
Oct. 15, 2004 (CN) 200410067189-2
Oct. 15, 2004 (CN) 200420091103-5

(51) Int. Cl. G05G 5/18; B23P 11/00

(52) U.S. Cl. 74/577 R; 29/428

(57) ABSTRACT

A linkage method and apparatus for linking a support frame and a pawl axle in a tie-down tool used on vehicles. The linkage includes an interface between a support frame and pawl axle, with the pawl axle inserted through the support frame, with the pawl fitted on the pawl axle and located on the outside of the support frame, with the pawl axle being a pin axle with a larger diameter head portion. The head portion of the pawl axle is located on the inside of the support frame, with a fastening mechanism at the outer end of the pawl axle to prevent the pawl from falling off the axle. The linkage between the support frame and pawl axle simplifies the manufacturing process through elimination of a welding step due to inserting the pawl axle inside-out through the support frame, and the use of a fastening device at the end of the pawl axle to prevent the pawl from falling off the axle. The secure connection between the two improves the safety and reliability of the ratchet during use, sustains a larger reaction force for the operation, and improves the useful life of the ratchet.

### CROSS-REFERENCE TO RELATED APPLICATIONS

The present application is a continuation of U.S. patent application Ser. No. 10/906,663, filed on Mar. 1, 2005 which in turn claims priority Under the Paris Convention for the Protection of Industrial Property to Chinese Patent Applications numbered 200410067189-2 and 200420091103-5 both filed on Oct. 15, 2004, the disclosures of all of which are herewith incorporated by reference in their entirety.

### FIELD OF THE INVENTION

The present invention relates to mechanical technology and in particular to a tying tool used on vehicles.

### BACKGROUND

During the transportation of goods with vehicles, it is necessary to tie down the goods to prevent loss of, or damage to, the goods due to bumping or falling off. A ratchet is an advanced tie-down tool. Ratchets are very well received among drivers due to their convenience and safety in tying down goods.

As shown in FIG. 1, a ratchet includes support frame 1 and belt axle 7, with a belt (not shown) wrapped around the belt axle 7, while one side of the belt axle 7 is equipped with a rotating device 8, and the other end is attached to a ratchet wheel 6. The rotating device 8 is used to tighten the belt on the belt axle 7. The belt is prevented from loosening by the action of ratchet wheel 6 and pawl 3.

The pawl 3 of the ratchet is fitted around the pawl axle 2. The pawl axle 2 is attached to support frame 1. With current ratchet designs, the larger diameter head portion 21 of the pawl axle 2 is located on the outside of the support frame 1, and the pawl axle end 23 is welded securely onto support frame 1 to achieve the secure attachment of the pawl axle 2 to support frame 1. When operating the ratchet, the front end of the pawl 3 must be mated with the teeth of the ratchet wheel as the ratchet tightens the belt to tie down the goods. In operation the rotating device turns the belt axle 7. The tension on the belt generates a large reverse torque on belt axle 7. This torque will act upon pawl 3 through ratchet wheel 6, thus generating a large reaction force on the pawl axle 2. After a period of use, the pawl axle 2 will become detached from the support frame 1 due to the great force acting on the weld at the pawl axle end 23. The pawl axle thus loosens and renders the whole ratchet useless.

In the meantime, the strength of the connection between the pawl axle 2 and the support frame 1 may be influenced by the welding related defects such as skewed weld, slag inclusion, porosity and so on.

In addition, the welding process requires extensive tooling. Further, the inconvenience of the welding process creates additional difficulty in repair in the event of loosening between the pawl axle 2 and the support frame 1. At times, a pawl breaks, requiring repair or ending the life of the ratchet.

For the foregoing reasons, there is a need for an improved linkage between the pawl axle and the support frame.

### SUMMARY

The present invention is directed to an improved linkage between a support frame and a pawl axle, based on the issues mentioned above. The linkage possesses characteristics such as secure connection, properly designed structures, ease of parts replacement, safety and reliability.

The objectives of the invention are realized through the following technical solutions: a linkage between a pawl axle and a ratchet support frame. With the pawl axle inserted through the support frame, the pawl is attached on the pawl axle on the outside of the support frame with the following characteristics: the pawl axle is a pin-axle, with a larger diameter head on one side that is inserted from the inside of the support frame, and with a fastening mechanism on the tail end of the pawl axle.

In the linkage between the support frame and pawl axle of the ratchet mentioned above, the head portion of the pawl axle is countersunk, and is flush with the inner surface of the support frame. Thus the belt on the inside of the support that is on the belt axle will not be in contact with the pawl axle, and the issue of belt sticking on the pawl axle can be prevented.

In the linkage between the support frame and pawl axle of the ratchet mentioned above, the mating between the support frame and pawl axle used is a tight fit. This ensures a secure connection between the pawl axle and the support frame.

In the linkage between the support frame and pawl axle mentioned above, the fastening mechanism is a riveted piece at the end of the pawl axle that is connected to the pawl axle. The fastening mechanism is used to prevent the pawl from falling off the pawl axle through riveting.

In the linkage between the support frame and pawl axle mentioned above, the fastening mechanism is a nut, while the end of the pawl axle is threaded and adapted to be screwed into the nut. This is to stop the pawl from falling off through using a nut.

In the linkage between the support frame and pawl axle mentioned above, the fastening mechanism is an insertion pin. A pinhole is disposed at the end of the pawl axle. The insertion pin is inserted into the pin-hole. The ratchet wheel will thus be secured on the pawl axle by the insertion pin.

In the linkage mentioned above between the support frame and the pawl axle, the fastening mechanism is a screw. A mating screw hole is disposed at the end of the pawl axle. The screw can be mated with the screw hole. This measure can be used to secure the pawl to prevent the pawl from falling off the pawl axle.

The linkage between the support frame and pawl axle is the direct insertion of the pawl axle through the support frame from inside out, and a fastening mechanism at the end of the pawl axle adapted to prevent the pawl from falling off the pawl axle. This reduces welding and simplifies the production process. In the meantime, it provides a more convenient means of replacing parts in the event of wear or damage to the components. In addition, the linkage between the pawl axle and the support frame of the invention ensures a secure connection between the two parts, thus providing reliable and safe operation. Specifically, the tight fit between the pawl axle and the support frame prevents the pawl axle from getting loose, thus increasing the mechanical strength of the pawl axle, allowing it to sustain higher loads, and extending the life of the ratchet.

The present invention together with the above and other advantages may best be understood from the following detailed description of the embodiments of the invention illustrated in the drawings, wherein:

### DRAWINGS

FIG. 1 is a mechanical illustration of a conventional ratchet;

FIG. 2 is a side view of the ratchet of FIG. 1;

FIG. 3 is a cross-sectional view of a first examplary embodiment of the linkage between the support frame and pawl axle according to principles of the invention;

FIG. 4 is a cross-sectional view of a second examplary embodiment of the linkage between the support frame and pawl axle according to principles of the invention; and

FIG. 5 is a cross-sectional view of a third examplary embodiment of the linkage between the support frame and pawl axle according to principles of the invention.

### DESCRIPTION

The following numbering scheme is used with respect to elements in the figures: support frame 1; pawl axle 2; head 21; pin hole 22; end of axle 23; pawl 3; nut 4; washer 5; ratchet wheel 6; belt axle 7; rotating mechanism 8; insertion pin 9; riveted piece 10.

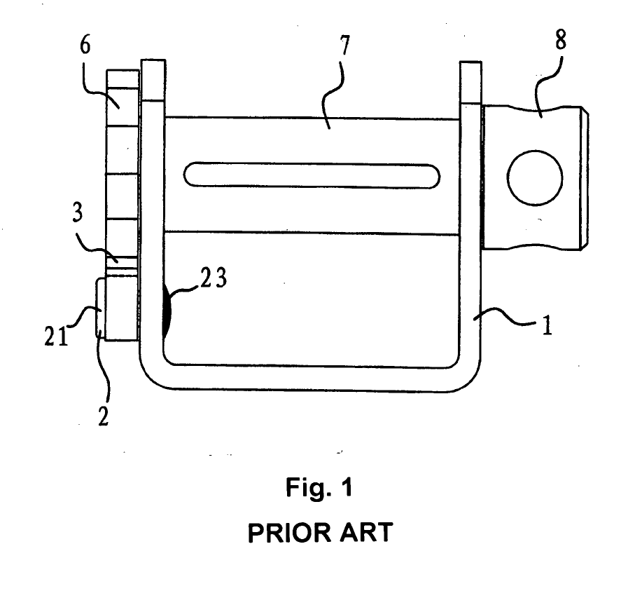

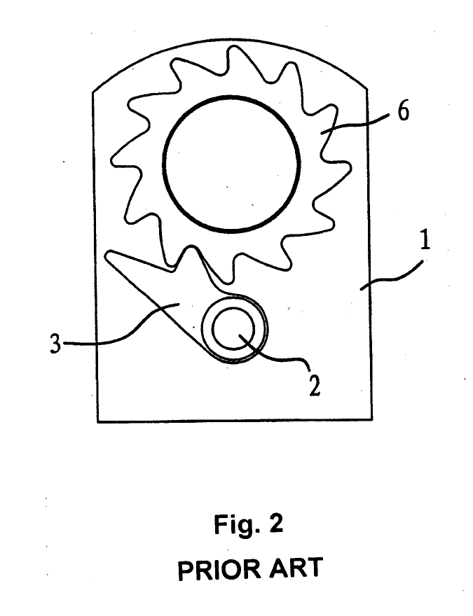

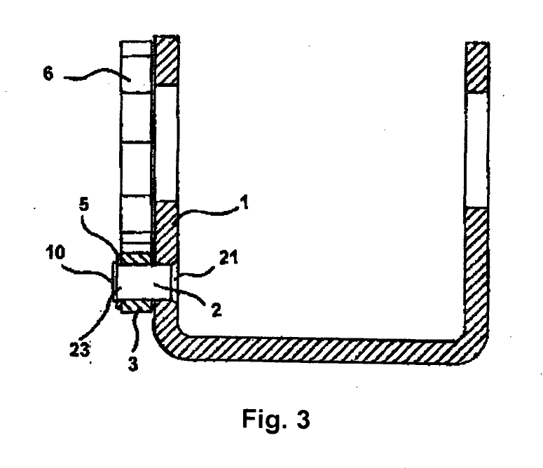

As shown in FIG. 3, the linkage includes an interface between the support frame 1 and pawl axle 2. As shown in FIG. 1 and FIG. 2, the pawl axle 2 goes through the support frame 1, while the pawl 3 is located on the outside of the support frame 1, and fitted onto the pawl axle 2.

The pawl axle 2 is a pin-axle. The diameter of the head 21 on the pawl axle 2 that is on the inside of the support frame 1 is larger than the rest of the pawl axle. The second end 23 of the pawl axle 2 has a fastening device to prevent the pawl 3 from detaching from the pawl axle 2.

In this embodiment, the head portion 21 of the pawl axle 2 is counter-sunk to a conical shape, and is matching in shape to the support frame 1. Thus the end of head 21 will be flush with the inner surface of the support frame 1. The mating between the support frame 1 and pawl axle 2 is a tight fit, thus assuring a secure connection between the support frame 1 and pawl axle 2.

FIG. 3 shows a first exemplary embodiment wherein the fastening device at the end 23 of the pawl axle 2 is a riveted piece 10. The riveted piece 10 is securely fixed to the end 23 of the pawl axle 2. There is also a washer 5 between the riveted piece 10 and pawl 3.

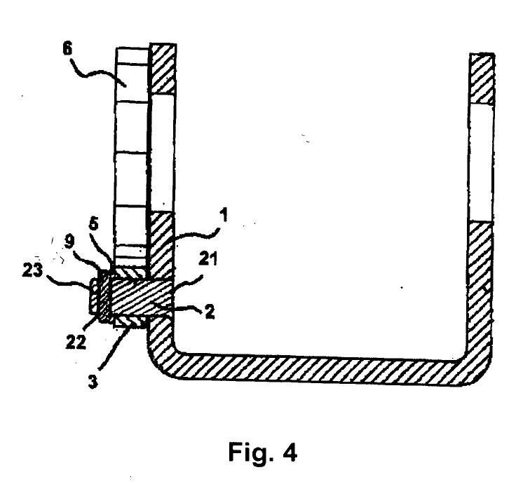

FIG. 4 shows a second exemplary embodiment wherein the fastening mechanism is a pin 9. Pin 9 is inserted into the pin-hole 22 at the end 23 of the pawl axle 2. Pawl 3 is securely connected onto pawl axle 2 by the pin 9. There is also a washer 5 between pin 9 and pawl 3. The washer is mated with the pawl axle 2.

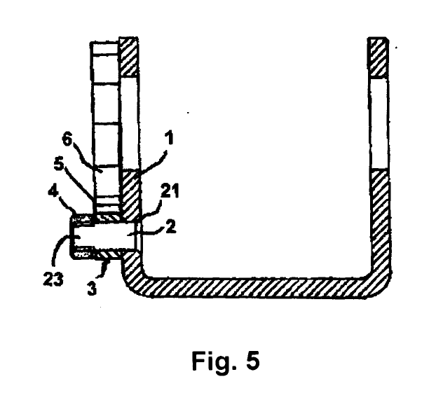

FIG. 5 shows a third exemplary embodiment wherein the fastening mechanism is a nut 4 coupled to a threaded region on the end 23 of the pawl axle 2. The nut 4 is used to prevent pawl 3 from falling off the pawl axle 2. There is also a washer 5 between nut 4 and pawl 3.

It is to be understood that the above-identified embodiments are simply illustrative of the principles of the invention. Various and other modifications and changes may be made by those skilled in the art which will embody the principles of the invention and fall within the spirit and scope thereof.

1. A ratchet comprising:
a support frame;
a pawl axle, said pawl axle being received through a bore of said support frame;
a pawl, said pawl being received onto said pawl axle outwardly of said support frame, said pawl axle being a pin axle having an enlarged diameter head portion at an inner end thereof, said head portion of said pawl axle being disposed
inwardly of said support frame wherein said head portion includes a countersunk head portion, said head portion having a face flush to an inner surface of said support frame; and a fastening mechanism, said fastening mechanism being disposed at an outer end of said pawl axle, said fastening mechanism being adapted to prevent said pawl from detaching from said pawl axle.

2. A ratchet according to claim 1, wherein a mating of said support frame and said pawl axle is tight-fit.

3. A ratchet according to claim 1, wherein said fastening mechanism includes a riveted piece disposed at said outer end of the pawl axle, said riveted piece being securely connected to the pawl axle.

4. A ratchet according to claim 1, wherein said fastening mechanism includes a nut, and wherein said outer end of the pawl axle includes an external thread, and wherein said pawl axle is connected to the nut by said external thread.

5. A ratchet according to claim 1, wherein said fastening mechanism includes a pin, and wherein said outer end of the pawl axle includes a pin hole, said pin hole being adapted to receive the pin therewithin.

6. A ratchet according to claim 1, wherein said fastening mechanism includes a screw, and wherein said outer end of the pawl axle includes an internally threaded hole, said internally threaded hole being adapted to receive said screw therewithin.

7. A ratchet according to claim 1, wherein said pawl axle is adapted to receive a washer thereon, said washer being disposed between said fastening mechanism and said pawl.

8. A method of forming a ratchet tie down mechanism comprising:
providing a support frame, said support frame having an internal surface and an external surface, said internal surface including first and second internal surface regions disposed in substantially parallel spaced relation to one another, said external surface having a first external surface region disposed in substantially parallel spaced relation to said first internal surface region and outward thereof, said external surface having a second external surface region disposed in substantially parallel spaced relation to said second internal surface region and outward thereof, said support frame having a bore surface region, said bore surface region being disposed between said first internal surface region and said first external surface region and defining a throughhole therebetween, said throughhole including a countersunk region proximate to said internal surface region;
providing a pawl axle having a shaft portion and a head portion, said shaft portion having a longitudinal axis, said head portion including an end surface region disposed substantially normal to said longitudinal axis, said head portion including a supporting surface region having a form generally complementary to said countersunk region of said bore;
inserting said shaft portion of said pawl axle through said bore so as to dispose said supporting surface region adjacent to said bore surface region of said countersunk region and so as to dispose said end surface region substantially flush with said first internal surface region;
providing a ratchet pawl having a ratchet pawl throughhole; and
disposing said ratchet pawl adjacent to said first external surface region so that said shaft portion of said pawl axle is disposed within said ratchet pawl throughhole.
